(19) United States
(12) Patent Application Publication
(10) Pub. No.: US 2016/0078716 A1
(43) Pub. Date: Mar. 17, 2016

(54) System and Methods for Remote Play of Real Arcade Games

(71) Applicant: Wayne Goldman, Newport Beach, CA (US)

(72) Inventor: Wayne Goldman, Newport Beach, CA (US)

(21) Appl. No.: 14/857,160

(22) Filed: Sep. 17, 2015

Related U.S. Application Data
(60) Provisional application No. 62/051,565, filed on Sep. 17, 2014.

(51) Int. Cl. G07F 17/32; G07F 17/34

(52) U.S. Cl. CPC G07F 17/3223; G07F 17/3218; G07F 17/3297; G07F 17/3295; G07F 17/34; G07F 17/3237

(57) ABSTRACT

A system for remotely playing an arcade game incorporating a player input device like a portable computer or smart phone with display, a computer application software, a internet with cloud capability, a game manager which controls access to arcade games and an application software, each adapted for remote play via cloud network and each capable of providing audio-visual feedback to a player remotely via video cameras at the game station.

### CROSS REFERENCE TO RELATED APPLICATIONS

The present application claims the benefit of U.S. Provisional Patent Application No. 62/051,565, filed on Sep. 17, 2014 and entitled “Systems and Methods for Remote Play of Arcade Games” which is herein incorporated by reference in its entirety.

### BACKGROUND

The present inventive subject matter relates to the Systems and Methods for Remote control and interaction with games in general and electromechanical arcade games in particular.

The prior art illustrates different systems for arcade games and/or remote controlling aka telepresence.

U.S. Patent Publication No. 2008/0108434 by Kerry Mann describes an internet enabled system which interacts with the mechanical amusement games of skill

U.S. Patent Pub No. 2006/0082642 by Wang et al. describes a business to business mobile teleconferencing system. The system depicted in '642 Patent publication includes a mobile robot that can be remotely operated from a station.

U.S. Pat. No. 6,139,429 by Stephen. P Shoemaker describes a video crane game. The '249 Patent depicts a video crane game including a display device, such as a video screen, for displaying images.

U.S. Pat No. 2,926,915 by F. D. Johns describes an automatic ticket dispensing skee ball machine. The '915 Patent describes an improved target game apparatus of the type including a scoring register operating in response to the striking of the target to display respective cumulative score values.

U.S. Patent Pub No. 2003/0060249 by Jack Gaurinieri describes an electronic amusement game. The '249 Patent publication describes a game apparatus having a lane surface and electronic scoring device.

U.S. Patent Pub No. 2006/0094489 by Fukazawa et al. describes a prize acquiring game apparatus. The '489 Patent publication describes a prize acquiring game apparatus which is capable of treating breakable prizes which can be acquired in a game.

U.S. Patent Pub No. 2006/0202953 by Pryor et al. describes man machine interface. The '953 Patent publication describes affordable methods and apparatus for inputting position, attitude (orientation) or other object characteristic data.

U.S. Patent Pub No. 2004/0242292 by Jan Hansen describes a system for virtual bowling. The '292 Patent publication describes an arrangement for a bowling simulator that has a bowling lane, a lane approach, a ball stop system, a pin pit, a lateral gutter and a bail return system.

The above mentioned prior arts describe the remote play of games based on the concepts old internet or describe the computerized games which are based on computer simulated environments like the virtual reality games.

Currently games in particular arcade games can be played and enjoyed at the arcade site where the game is located. These games offers the players a mastery over manipulating controls in order to accumulate scores over the time, compete with each other and the like. Examples of such Arcade games are pinball machines, claw game, pachinko, computerized simulations of war games or sports events etc. For example a claw game uses a joystick to control lateral movement of a claw in which the player attempts to position, drop the claw to grab stuffed animals and other prizes in a transparent box. Usually one play per credit, the player moves the joystick within a time limit and presses a button to drop the claw-like attachment into the bin. The machine then automatically closes its claw, raises it and moves back into a stationary position over a chute. If any prize is grabbed it gets dropped in the chute for the player to retrieve.

Recent developments in the digital arena have offered the mankind with new technologies namely, cloud servers, smart phones, tablet computers, portable computers and the like. Cloud server with cloud computing capabilities delivers rapid computing as a service rather than a product, whereby shared resources, software, and information are provided to computers, smart phones, tablet computers and other devices as a utility (like the electricity grid) over a network (typically the Internet). Smart phones and tablets with the most advanced computing capabilities host a bunch of built-in features and available applications. It is highly desirable to play the arcade games using the smart phones or tablets from a remote location using cloud computing technology though the internet. This will allow many people to enjoy friction-less and direct play-ability of the arcade games at the comfort of their homes at the same time experiencing the feeling of being at the arcade game site.

The aforementioned would result in real interactive player participation in the remote arcade games from a distance.

### SUMMARY

The present inventive subject matter overcomes problems in the prior art by providing a system for remotely playing an arcade game incorporating a player input device like a portable computer or Smart Phone with display, a computer application software, cloud network, a router, a web server, a port switch for connecting various arcade games, each adapted for remote play via internet connection and internet protocol and each capable of providing visual and/or audio feedback to a player remotely via internet connection and internet protocol.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

These and other features and advantages of the present description will be better understood by reference to the following drawings wherein:

FIG. 1 is a schematic diagram of the system architecture for remotely playing Arcade games.

FIG. 2 is a snapshot for Home Screen.

FIG. 3 is a snap shot for Register Screen.

FIG. 4 is a snapshot for profile screen

FIG. 5 is a snapshot for signed in home screen.

FIG. 6 is a snapshot for coordinates screen.

FIG. 7 is a snapshot for social options screen

FIG. 8 is a Flow diagram for remote play of arcade games.

### LIST OF REFERENCE CHARACTERS

100—System for Arcade games
110 or 110A/110B/110C—Player
120 or 120A/120B/120C—Computer/tablet/Phone
130—Internet with cloud capability
140—Game Manager
150 or 150A/150B/150C/150D—Game Centre with multiple machines
200—Home screen details
210—Playername
220—Password
300—Snapshot of Registration page
310—Screen page for Registration Page
320—Submit
400—Snapshot of the profile Screen
410—Screen page for Profile Screen
500—Snapshot of the Home Screen
510—Screen page for Home Screen
600—Snapshot of the Coordinates Screen
610—Birds eye view
620—Claw positioning
700—Snapshot of the Coordinates Screen
700—Snapshots of Social options Screen
710—Screen page for Social options Screen
720—Social Media options
800—Flow diagram
810—Game initiation
820A and 820 B—Payment options
830—Play the game
840A and 840B—Win and lose option
850A and 850B—Request Address or Email Address
860A and 860B—Toy shipped or discount coupon emailed.

### DETAILED DESCRIPTION

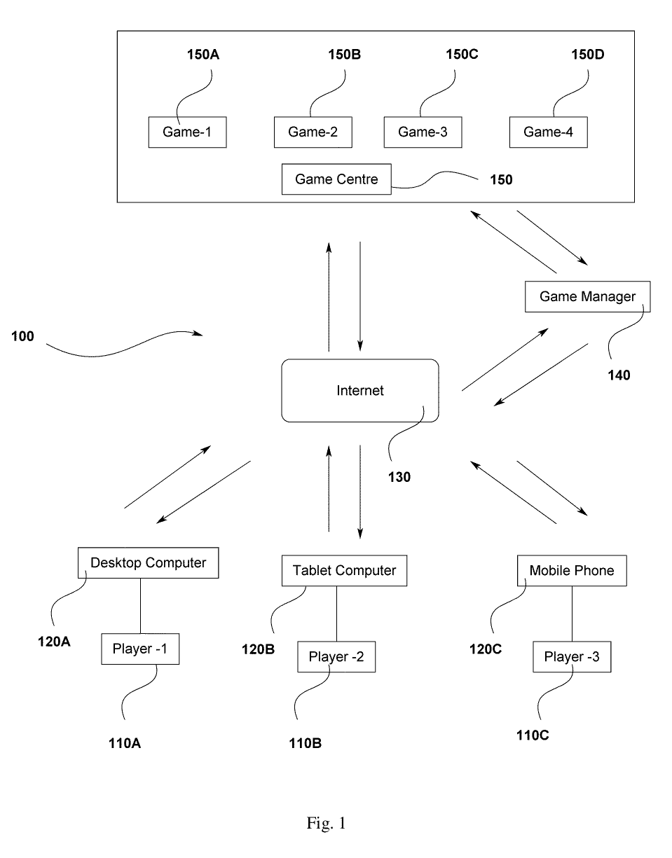

Representative embodiments according to the inventive subject matter are shown in FIG. 1, wherein similar features share common reference numerals.

“Player” shall typically mean a single player interacting with the Program, but does not have to be so limited, such that teams of individuals may be a “Player” interacting with the program.

“Arcade Game” shall mean any physical game as described in this application unless noted otherwise. A “game machine” is an “arcade game machine” as defined below. On an exemplary note the arcade game could be a claw game, a skee ball game, a bowling game, a casino game, a carnival game, a slot machine game, a horse derby game, a clown balloon water gun game or any real physical game.

Persons skilled in the art will recognize that many modifications and variations are possible in the details, materials, and arrangements of the parts and actions which have been described and illustrated in order to explain the nature of this concept and that such modifications and variations do not depart from the spirit and scope of the teachings and claims contained therein. The invention here is described in general to any arcade game and for exemplary purpose the description given below is related to a arcade game played on a smart phone but the same can be played with a tablet computer or personal/portable computer.

Referring to FIG. 1, a non-limiting embodiment of the invention is illustrated as a block diagram. FIG. 1 depicts a schematic diagram of a system for playing Arcade Games 100, comprising a player 110A/110B/110C who connects to the internet with cloud capability 130 through a personal computer 120A or a portable tablet computer 120B or a smart phone 120C having a display. The smart phones/tablet computers can be operated based on different mobile operating software like Android, iOS, Windows or Blackberry.

The smart phones have motion sensors embedded in them which serve as the input points from where the player communicates the player initiated instructions for remotely playing the Arcade games. The internet 130 connects the player to the game center 150 with multiple games like Game-1 150A game-2 150B, Game-3 150C and Game-4 150D. The player 110A/110B/110C downloads an application software package from the internet 130 which customizes the player 110A/110B/110C for the remote play of Arcade games. A Game Manager 140 connects the Game center to the players which mainly constitutes a game control board and access to the camera placed at the Game center. The Game manager sends the player instructions to the game center and in return sends back the audio/visual cues to the player.

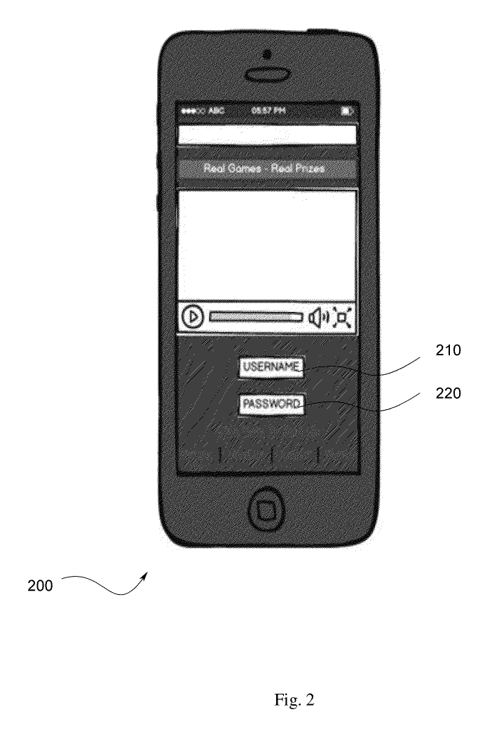

Referring to FIG. 2 which depicts a snap shot 200 of the home screen on a smart phone which would be available once the player opens the arcade game website on a mobile phone. This web screen mainly provides the players with introductory information about the remotely playable Arcade game, tricks and tips for playing and winning the Arcade games. As the player 110 submits the username 210 and password 220, the player 110 has access to register and to create a unique profile for oneself and to share information through social media options.

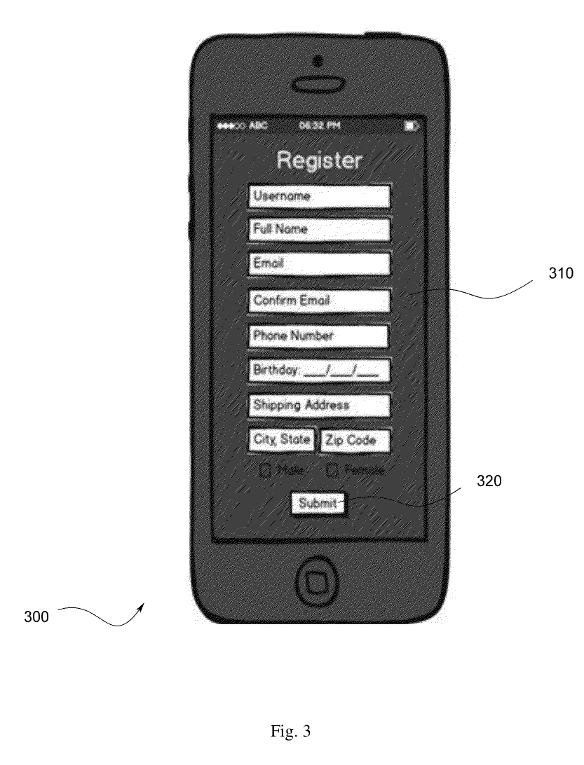

FIG. 3 describes the details of the registration screen and 300 shows a snapshot of the registration screen as seen on a smart phone. At this stage the details like username, Full Name, Email address, Phone Number, Address as shown on the screen 310 is submitted 320 by player 110 which helps in giving a unique identity to each player.

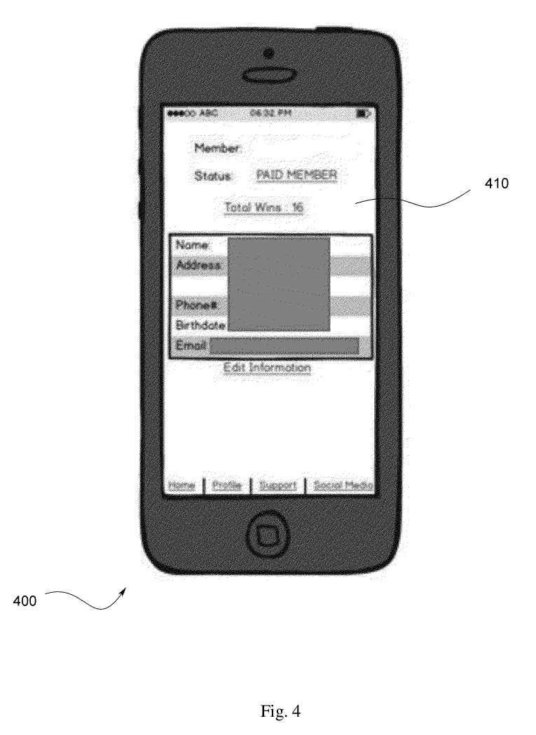

FIG. 4 shows the details of the player profile screen. 400 shows the snapshot for the profile screen as seen on a smart phone. This web screen 410 may also give details of the player's successful wins in the past and his/her achievement history.

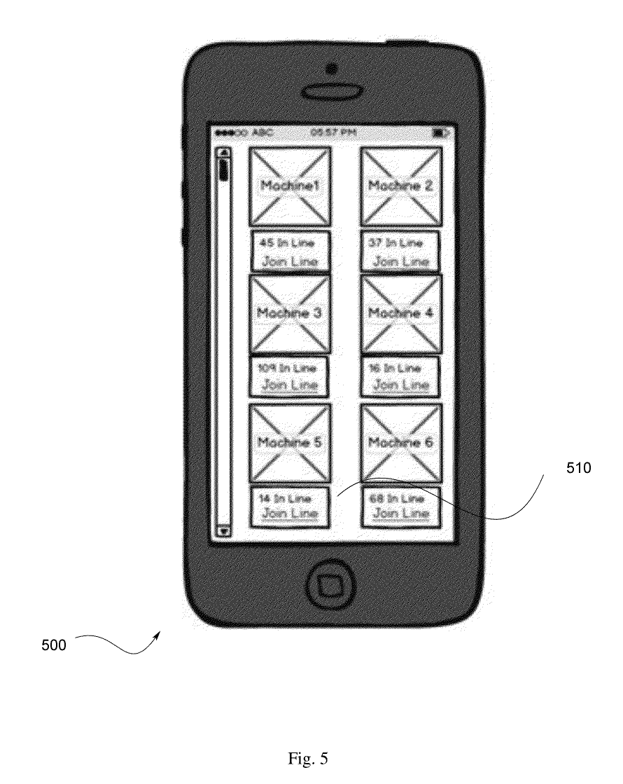

FIG. 5 shows details of the signed in home screen and 510 show the snapshot of the signed in home screen as seen on smart phone. This web screen mainly provides with the most current status report for the available games for play and an estimate of the wait time.

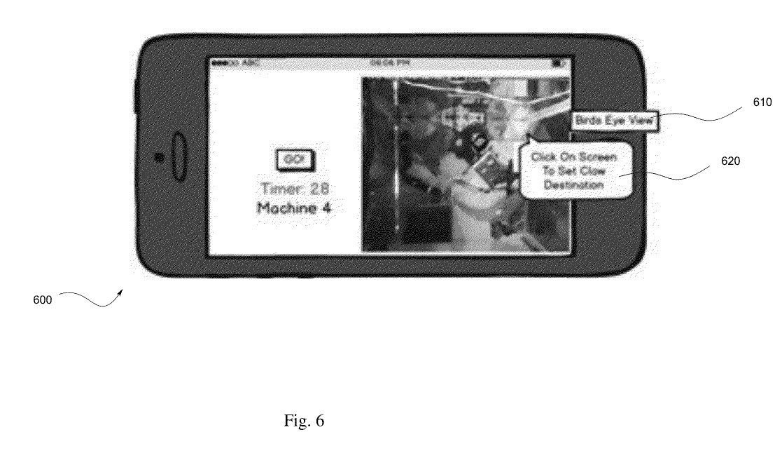

Now describing a preferred embodiment of the present inventive subject matter which is for playing of a claw game. FIG. 6 shows the details of coordinates screen and 600 shows the snapshot of the coordinates screen as seen on a smart phone. The one or more video cameras at the game station may be positioned for different views to get a better understanding location details with respect to the particular game requirements.

The Bird's eye view 610 gives the player 110 a real view of the game in action and helps in setting the claw at the right destination by just clicking 620 on the screen. The touch screen capabilities in all portable electronics like tablets, phones offer easy maneuverability for playing these games.

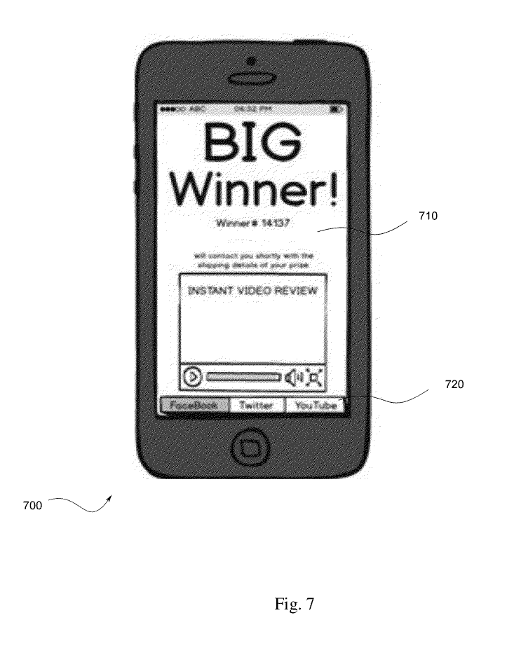

FIG. 7 shows the details of the social options available for the player. And 700 shows of a snapshot of the screen 710 which can be shared with friends and other players though social networking 720. This particular feature helps in popularizing the games among the social networking community and also to share one's success stories among friends and family. As these games can be played remotely everyone can take advantage of this unique feature and enjoy the games from their own locations.

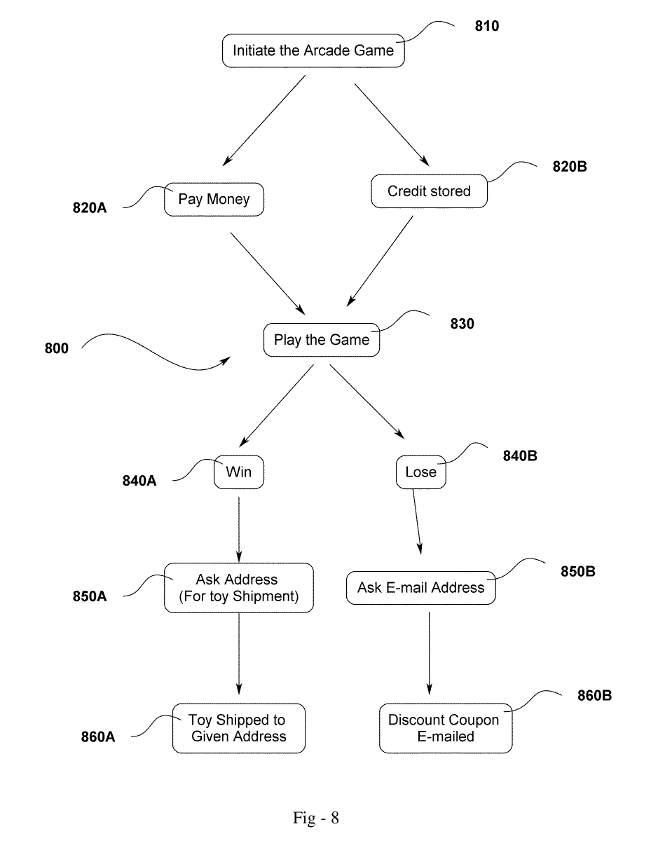

Now Referring to FIG. 8, which represents a general flow diagram 800 for the remote play of arcade games. Initially the player starts the arcade games 810 by either paying money 820A or by using his/her saved credit 820B. After the payment the player plays the game 830 and one can win 840A or lose 840B. If the player wins the game an address for the shipment of the toy is requested 850A and the toy is shipped to the given address 860A. If the player loses the game then an email address is requested 850B and a discount coupon is emailed to the given email address 860B.

Those skilled in the art will recognize modifications and substitutions to the specific embodiments disclosed herein.

I claim:

1. A system for remotely playing an arcade game comprising:
an player station, the player station connected to a cloud server with cloud computing capability;
a arcade game station, the arcade game station located at a remote site connected to the server and able to receive player initiated instructions;
a game manager; the game manager assisting in information transfer between the player station and the arcade game station.

2. The system as defined in claim 1 wherein the player station includes a smart phone

3. The system as defined in claim 1 wherein the player station includes a tablet computer

4. The system as defined in claim 1 wherein the player station includes a personal computer.

5. The system as defined in claim 2 further having an visual feedback from a video camera connected to the game machine.

6. The system as defined in claim 1 further comprising an application software package loadable in the player station which enables the player to play the Arcade game.

7. The system of claim 1 wherein the arcade game is a claw game.

8. The system of claim 1 wherein the arcade game is a skeeball game.

9. The system of claim 1 wherein the arcade game is a bowling game.

10. The system of claim 1 wherein the arcade game is a casino game.

11. The system of claim 1 wherein the arcade game is a carnival game.

12. The system of claim 1 wherein the arcade game is a slot machine game.

13. The system of claim 1 wherein the arcade game is a horse derby game.

14. The system of claim 1 wherein the arcade game is a clown balloon water gun game.

15. An apparatus for a remote play of an arcade game comprising:
a remotely located Arcade game routed to the player through a cloud server and having a web server adapted to receive player initiated instructions to assist in playing of the arcade game.

16. The apparatus as defined in claim 10 further comprising:
at least one video camera as part of the game machine for generating visual feedback cues for the arcade game player.

17. The apparatus as defined in claim 11 further comprising:
a game application software package downloadable from the cloud server for use by the game player for customizing the player station.

18. A method for remotely playing an arcade game comprising the steps of:
providing a player station having an input device and a display;
connecting the player station to the cloud network;
connecting at least one remotely located arcade game to the player through a cloud network;
transmitting the player's player initiated instructions to the arcade game;
providing visual feedback to the player from a video camera.

19. The method as defined in claim 15 wherein the step of connecting the player station to the internet through a web server comprises the steps of:
downloading an application software package from the cloud network customizing the player station with the application software package to the task of remotely playing the arcade games.
